(19) United States
(12) Patent Application Publication
(10) Pub. No.: US 2008/0295355 A1
(43) Pub. Date: Dec. 4, 2008

(54) METHOD OF INCREASING THE EFFICIENCY OF A DRIER, PARTICULARLY A STREAM DRIER

(75) Inventor: Marek Sieredzinski, Radom (PL)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Marek Sieredzinski, Radom (PL)

(21) Appl. No.: 12/124,760

(22) Filed: May 21, 2008

(30) Foreign Application Priority Data
May 30, 2007 (PL) P382542

(51) Int. Cl. F26B 3/00

(52) U.S. Cl. 34/516

(57) ABSTRACT

A method of increasing the efficiency of a drier, particularly a stream drier for loose and flammable materials, particularly cut tobacco, working with a gaseous drying agent under a working pressure from 5 kpa to 10 MPa, measured as an absolute pressure, preferably the drying agent being superheated steam. A pressurized process gas, preferably waste steam, particularly coming from the interior of the drier, is passed through a dosing-separating valve, preferably a rotary vane feeder (1′) mounted behind the stream drier (2), particularly through its movable section with the dried material being emptied therefrom, the steam being returned from a release valve (10) for reusing it in the process of diluting the air, the steam being regarded as a technology waste product.

### CROSS-REFERENCE TO RELATED APPLICATIONS

The present application claims the benefit of priority of Polish Patent Application P382542; filed May 30, 2007. The entire text of the priority application is incorporated herein by reference in its entirety.

### FIELD OF THE DISCLOSURE

This disclosure relates to a method of increasing the efficiency of a drier, particularly a stream drier, used for dry loose and flammable materials such as driers for cut tobacco, and working with the use of a gaseous drying agent, particularly superheated steam.

### BACKGROUND

Many types of driers are known in the art, especially stream driers, working with a gaseous drying agent, in which superheated steam is used as a process gas of a temperature close or even higher than the ignition temperature of the dried material. Such conditions produce the necessity of removing oxidizing gases, particularly oxygen, entering the drier with the air. Oxygen contained in the air delivered into the drier may cause an explosion or fire, and also it is a reagent in chemical processes, which affects properties of the material. Due to their operation principle, dosing-separating valves, used so far, let they, air (oxygen) into the drier, leading to disadvantageous changes in the composition of the process gas. Its regeneration needs significant expenditure of energy for the process of removing the oxygen from the whole volume of the process gas contained in the drier.

EP 0528227 A1 describes a method of drying tobacco material in a stream drier, in which, preferably, superheated steam is used as a drying agent. In the passage feeding the tobacco material to the drier a double rotary vane feeder is used, separating the stream drier from the surroundings and making it possible to feed the tobacco material to the drier. Another single feeder is located in the output conduit from the gas separator situated in the drier.

U.S. Pat. No. 4,791,942 discloses a design of a rotary vane feeder, as self-standing device for processing tobacco material, before feeding the material into another device. In the feeder housing there are openings leading to pressure chambers connected with conduits feeding superheated steam or carbon dioxide, as the process gas for processing the tobacco material, and with a conduit attached to the vacuum assembly.

### SUMMARY OF THE DISCLOSURE

The subject matter of the disclosure is a method of increasing the efficiency of a drier, particularly a stream drier for loose or flammable materials, particularly cut tobacco, the drier working with a gaseous drying agent under a working pressure from 5 kPa to 10 MPa, measured as an absolute pressure.

Preferably, superheated steam is used as the drying agent.

According to the disclosure a pressurized process gas, preferably superheated steam,

particularly coming from the interior of the drier, is passed through a dosing-separating valve, preferably a rotary vane feeder mounted behind the stream drier, particularly through its movable section with the dried material being emptied therefrom, the steam being returned from a release valve for reusing it in the process of diluting the air, the steam being regarded as a technology waste product.

The method according to the disclosure is a continuous process and makes it possible to use in the drier a working pressure in the range from 5 kPa to 10 MPa, measured as an absolute pressure.

### BRIEF DESCRIPTION OF THE DRAWINGS

The disclosure is illustrated by an embodiment, shown in the accompanying drawings, in which:

FIG. 1 shows schematically a system for carrying out the method according to the disclosure, and

FIG. 2 shows schematically a cross-sectional view of the feeder.

### DETAILED DESCRIPTION

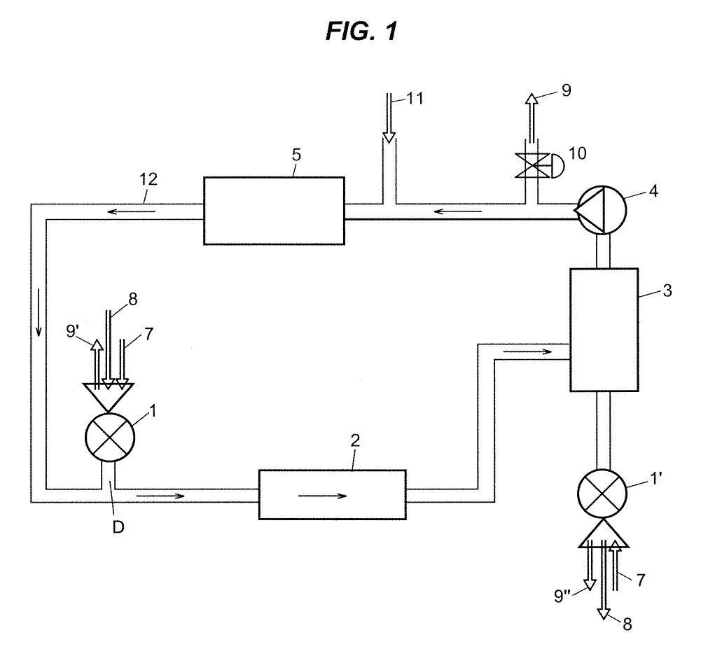

As shown in FIG. 1, cut tobacco 6 is delivered into the feeder 1, and then it is fed to a stream drier 2 via a mixing zone 0. After drying, the tobacco flows out of the device via a tobacco separator 3 and a feeder 1′. The process gas, particularly steam, is recirculated by a recirculation pump 4 to a steam superheater 5. The process gas leaving the steam superheater 5 collects the dried material from the mixing zone 0. The process gas mixed with the dried substance, particularly steam, flows into a stream drier 2. The dried material is removed from the system, through the outlet 8 of the feeder 1′. Behind the recirculation pump 4, considering the direction of the flow of the process gas denoted with the number 12, there are installed a release valve 10 with an outlet 9, and still further an inlet 11 for entering fresh process gas free from the air, in order to reduce the air concentration in the process gas contaminated by the air circulating inside the drier.

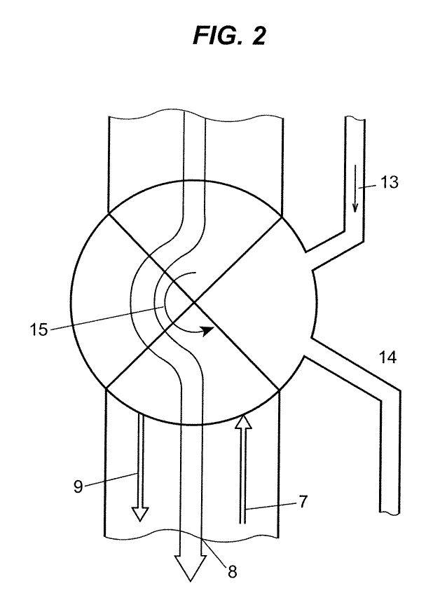

FIG. 2 shows schematically a cross-sectional view of the feeder 1 mounted at the outlet of the stream drier 2. It should be noted that in the disclosed solution both feeders 1, 1′ function as dosing-separating valves and due to their design and the principle of operation the noxious air is continuously flowing into the drier, which is denoted with the number 7 in FIG. 2. The air introduced into the system increases the concentration of oxygen in the stream of the superheated steam, the latter being the process gas in this embodiment. To reach the concentration of oxygen in the process gas, which is recommended for the drying process, usually below 4% by volume, a fresh portion of the process gas is introduced via the inlet 11 Using the fresh, i.e., free from the air, process gas, here the steam, the whole amount of the process gas present in the circulation system of the drier is diluted, reducing the concentration of oxygen. The gas used for diluting the process gas, contaminated with oxygen as well as a waste of gas coming from the conduit of the drier, is removed via the outlet 9 and the release valve 10, and the outlet 9′.

FIG. 2 shows schematically a cross-sectional view of the feeder 1′ with denotation of individual flows of the agent according to the disclosure. The dried material, which arrived at the feeder 1′ from the stream drier 2, flows through its sections and is removed through the outlet 8. As shown in the drawing, vanes of the feeder 1′ rotate in the direction shown by the arrow 15. The excess of the process gas is removed through the outlet 9″. Superheated steam from the interior of the drier, collected from the outlet 9, is introduced via the inlet 13 into the section of the feeder 1′, emptied of the dried material, i.e., the section rotating towards the stream drier 2, the steam being next discharged via the outlet 14 as a process waste.

Thus, a washer for the process gas is obtained in the feeder 1′. The air, which entered the feeder 1′, due to the principle of operation of this device (denoted by the reference number 7), is subjected to significant dilution this section of the feeder. Thus, the gas significantly washed from the air will enter the interior of the drier.

A compact pump of a volumetric flow, a little bit higher than the volume of water removed from the dried material in a form of vapor for given thermodynamic conditions, may be used to ensure the flow through the section of the feeder 1′.

The process gas flowing through the section of the feeder 1′ washes out the air with oxygen and causes removal of unnecessary amount of the process gas via the outlet 14 outside.

The benefit of the disclosure is that the air in the section of the feeder 1′ is significantly diluted. Significant reduction of entering the air, thus also oxygen, significantly, or even completely, eliminates the necessity of delivering clean superheated steam to the drier 2.

What is claimed is:

1. A method of increasing the efficiency of a drier working with a gaseous drying agent under a working pressure from 5 kPa to 10 MPa, measured as an absolute pressure, comprising passing a pressurized process gas through a dosing-separating valve, and returning the pressurized process gas from a release valve (10) for reusing it in the process of diluting the air.

2. The method of claim 1, wherein the drier is a stream drier (2) for loose and flammable materials.

3. The method of claim 2, wherein the loose and flammable materials is cut tobacco.

4. The method of claim 1, wherein the gaseous drying agent is superheated steam.

5. The method of claim 4, wherein the pressurized process gas is waste steam coming from the interior of the drier.

6. The method of claim 1, wherein the dosing-separating valve is a rotary vane feeder (i) mounted behind the stream drier (2).

7. The method claim 6, wherein the pressurized process gas is pass through the moveable section of the rotary vane feeder, with the dried materials being emptied therefrom.

8. The method of claim 5, wherein the waste steam is a technology waste product.
